(19) United States
(12) Patent Application Publication
(10) Pub. No.: US 2007/0144015 A1
(43) Pub. Date: Jun. 28, 2007

(54) MECHANICALLY ASSISTED SCISSORS

(76) Inventors: Michael E. Peterson, Fairfield, CT (US); Daniel Brady, Old Windsor (GB)

Correspondence Address: WHYTE HIRSCHBOECK DUDEK S.C., ONE EAST MAIN STREET, SUITE 300, MADISON, WI, 53703-3300, US

(21) Appl. No.: 11/557,300

(22) Filed: Nov. 7, 2006

Related U.S. Application Data
(60) Provisional application No. 60/734,488, filed on Nov. 8, 2005.

(51) Int. Cl. B26B 13/00

(52) U.S. Cl. 30/262; 30/257

(57) ABSTRACT

The present invention is a mechanically assisted scissors that enhances user comfort, ease of use, and safety. The scissors includes first and second scissor members that have first and second blades and first and second handles, respectively. The scissors has a biasing means enclosed within a chamber, and a locking mechanism.

### CROSS REFERENCE TO RELATED APPLICATIONS

This application is related to and claims the benefit of U.S. Provisional Application Ser. No. 60/734,488 on Nov. 8, 2005, the contents of which are incorporated herein by reference thereto.

### BACKGROUND OF THE INVENTION

The present invention relates to shears and scissors, in particular, scissors that are mechanically assisted for easier use.

Shears and scissors that are biased to an open position are known in the art. Biasing eliminates the need for the user to manually separate the blades after completing a cutting action. Many such biased, or mechanically assisted, shears employ a spring means for biasing the tool to an open position. The mechanical assistance offered by such spring-biased scissors often removes the need for finger and thumb loops in the scissors, which loops are helpful in manually separating the blades of conventional scissors that lack a biasing means. Spring-biased shears may be actuated simply by gripping the two handles to overcome the force of the biasing means, or by applying pressure from the thumb against one handle, while holding the other handle in the palm and fingers. For certain users, such as those suffering from arthritis or other lack of strength or dexterity in the fingers, using a grip-actuated mechanically assisted scissors is easier than using conventional, non-biased scissors with finger and thumb loops.

In spite of these advantages, mechanically assisted scissors of the prior art present certain problems. One such problem is that these scissors often contain exposed metal springs, creating a danger of user injury through pinching by the spring. The designs in the prior art also expose the spring to air, moisture, and water, increasing the risk of corrosion and shortening the tool's useful life. A further problem with the designs of spring-biased scissors in the prior art is that these scissors, often lacking finger loops, may easily slip from the user's hand, creating a risk of injury to the user or damage to the tool. Other problems with the biased scissors of the prior art include discomfort for, and poor control by, the user because of poorly shaped or textured handles. Accordingly, there is a need for a mechanically assisted scissors that does not have an exposed biasing means that protects the user from risk of injury, that reduces the risk of damage to the tool by dropping, and that increases comfort of use.

### SUMMARY OF THE INVENTION

The mechanically assisted scissors of the present invention encloses a biasing means by providing a chamber around the pivot of the scissors in which the biasing means is positioned.

The present invention may have ergonomically curved and textured handles to enhance user comfort and ease of use.

The scissors of the present invention has a first scissor member that has a top handle and a first blade, and a second scissor member that has a bottom handle and a second blade. A pivot assembly pivotally connects the first scissor member to the second scissor member. The first scissor member has a first cavity, and the second scissor member has a corresponding second cavity. When the scissor members are pivotally connected, the first and second cavities are opposed to one another and align with one another, forming a chamber. This chamber houses a biasing means, for biasing said first scissor member and said second scissor member to an open position.

The handles of the first and second scissor members may be angularly offset in relation to the blades of the first and second scissor members. The scissors can have a finger guard that extends from the bottom handle, and the scissors also may have a tether.

In another embodiment, the present invention includes a scissors comprising a first scissor member comprising a top handle, a first cavity, and a first blade having a first inner surface. A second scissor member is also included comprising a bottom handle, a second cavity, and a second blade having a second inner surface. A pivot assembly connects the first scissor member and the second scissor member, whereby the first inner surface and the second inner surface are oriented to face one another, thereby aligning the first and second cavities with one another to form a chamber around the pivot assembly when the first and second scissor members are pivotally connected. A biasing means is located within the chamber for biasing the first scissor member and the second scissor member to an open position. An open angle limiter is peripheral to the chamber. Also included is a locking mechanism for restricting the first scissor member and the second scissor member to a closed position.

In another embodiment, the present invention includes a scissors comprising a first and second scissor member. The first scissor member comprises a top handle and a first blade having a first inner surface. The first blade extends forward of the top handle and ends at a first distal end. The top handle extends rearwardly of the first blade and ends at a first proximate end. The top handle may be slightly curved, and the top handle may have a rigid base material and a resilient grip material. The second scissor member comprises a bottom handle and a second blade having a second inner surface. The second blade extends forward of the bottom handle and ends at a second distal end. The bottom handle extends rearwardly of the second blade and ends at a second proximate end. The bottom handle may be slightly curved, may have a finger guard, may have a rigid base material and a resilient grip material, wherein the grip material is ribbed. Also included is a pivot assembly, which connects the first scissor member and the second scissor member, whereby the first inner surface and the second inner surface are oriented to face one another. The first scissor member and the second scissor member are pivotable between an open position, wherein the first and second blades are oriented transversely to one another and a closed position, wherein the first and second blades are oriented approximately parallel to one another. The first scissor member has a first cavity and the second scissor member has a second cavity, whereby the first and second cavities are opposed to one another and aligned with one another when the first and second scissor members are pivotally connected to form a chamber around the means for pivotally connecting the first and second scissor members. Also included is a biasing means within the chamber for biasing the first scissor member and the second scissor member to an open position. An open angle limiter peripheral to the chamber also is included. A locking mechanism is also included for restricting the first scissor member and the second scissor member to a closed position.

### BRIEF DESCRIPTION OF THE DRAWINGS

Preferred embodiments of the invention are described below with reference to the following figures, which are provided for illustrative purposes only. The figures illustrate a best mode presently contemplated for carrying out the invention.

FIG. 1 is a perspective view of one embodiment of the scissors of the present invention in a closed position.

FIG. 2 is a left elevational view of the scissors of FIG. 1 in a closed position.

FIG. 3 is a right elevational view of the scissors of FIG. 1 in a closed position.

FIG. 4 is a left elevational view of the scissors of FIG. 1 in an open position.

FIG. 5 is an exploded perspective view of the scissors of FIG. 1.

FIG. 6 is a right elevational view of the first scissor member of the scissors of FIG. 1.

FIG. 7 is a left elevational view of the second scissor member of the scissors of FIG. 1.

FIG. 8 is a cross-sectional view of the scissors of FIG. 1 along line 8-8 shown in FIG. 2.

FIG. 9 is a perspective view of another embodiment of the scissors of the present invention in a closed position.

FIG. 10 is a left elevational view of the scissors of FIG. 9.

### DETAILED DESCRIPTION OF PREFERRED EMBODIMENTS

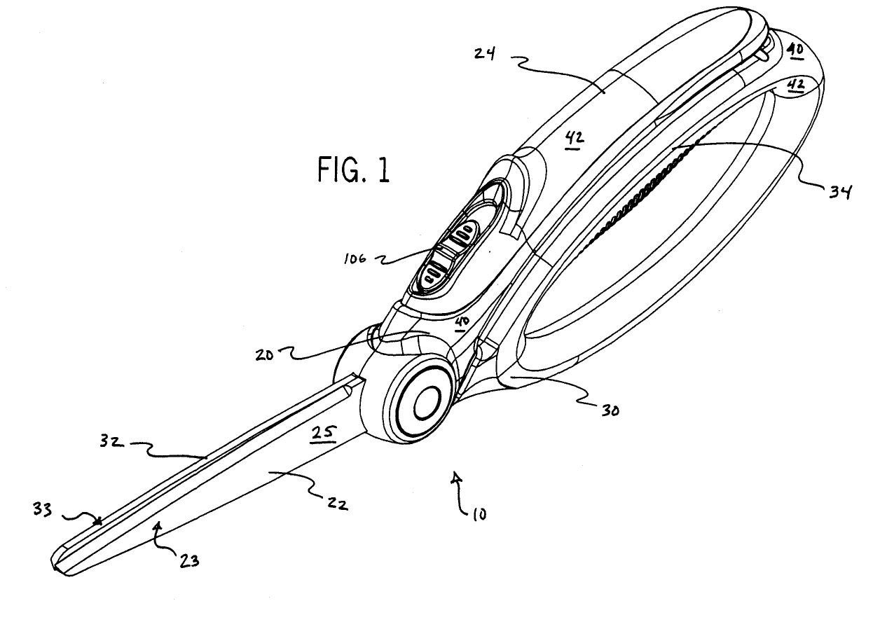

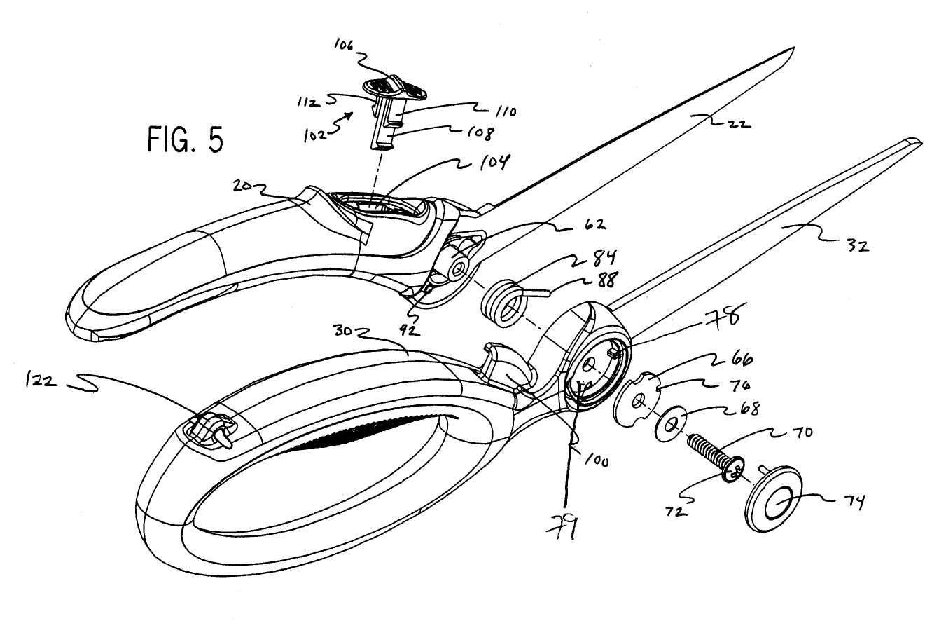

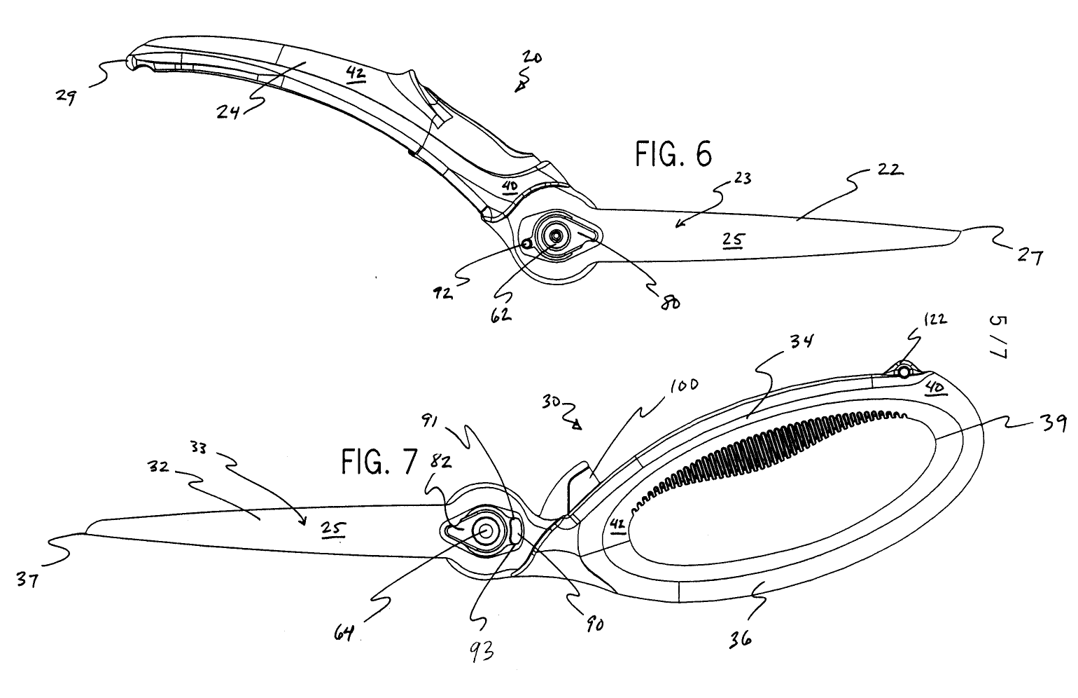

FIGS. 1-7 show an exemplary embodiment of a scissor assembly 10 according to the present invention. The scissor assembly 10 has a first scissor member 20. The first scissor member 20 has a first blade 22 and a top handle 24. The first blade 22 has a first inner surface 23. As shown in FIGS. 6 and 7, the first blade 22 extends forwardly of the top handle 24 and ends at a first distal end 27. The top handle 24 extends rearwardly of the first blade 22 and ends at a first proximate end 29. The first scissor member 20 may have a rigid base material 40, for example, metal or an appropriate engineering material, such as acetyl resin, acrylic resin, nylon, polyethylene, or acrylonitrile-butadiene-styrene (ABS) resin, more preferably ABS resin. For ergonomic reasons, the first scissor member 20 also may have a resilient and/or flexible grip material 42, for example, an elastomer, preferably thermoplastic elastomer (TPE). Ergonomics and user comfort may be enhanced if the top handle 24 is slightly curved, as shown in the embodiment of FIGS. 1-4. The first scissor member 20 has a locking switch 102, shown in FIG. 5, used to secure the scissors assembly 10 in a closed position, as shown.

The scissor assembly 10 also has a second scissor member 30. The second scissor member 30 has a second blade 32 and a bottom handle 34. The second blade 32 has a second inner surface 33. As shown in FIGS. 6 and 7, the second blade 32 extends forwardly of the bottom handle 34 and ends at a second distal end 37. The bottom handle 34 extends rearwardly of the second blade 32 and ends at a second proximate end 39. The second scissor member 30 may have a rigid base material 40, for example, metal or an appropriate engineering material, such as acetyl resin, acrylic resin, nylon, polyethylene, or ABS resin, more preferably ABS resin. For ergonomic reasons, the second scissor member 30 also may have a resilient and/or flexible grip material 42, for example, an elastomer, preferably TPE. Ergonomics and user comfort may be further enhanced if the bottom handle 34 is slightly curved and the grip material 42 is ribbed, as shown in the embodiment of FIGS. 1-4. In the embodiment shown in FIGS. 1-7, the second scissor member 30 has a finger guard 36 formed integrally with the second handle 34.

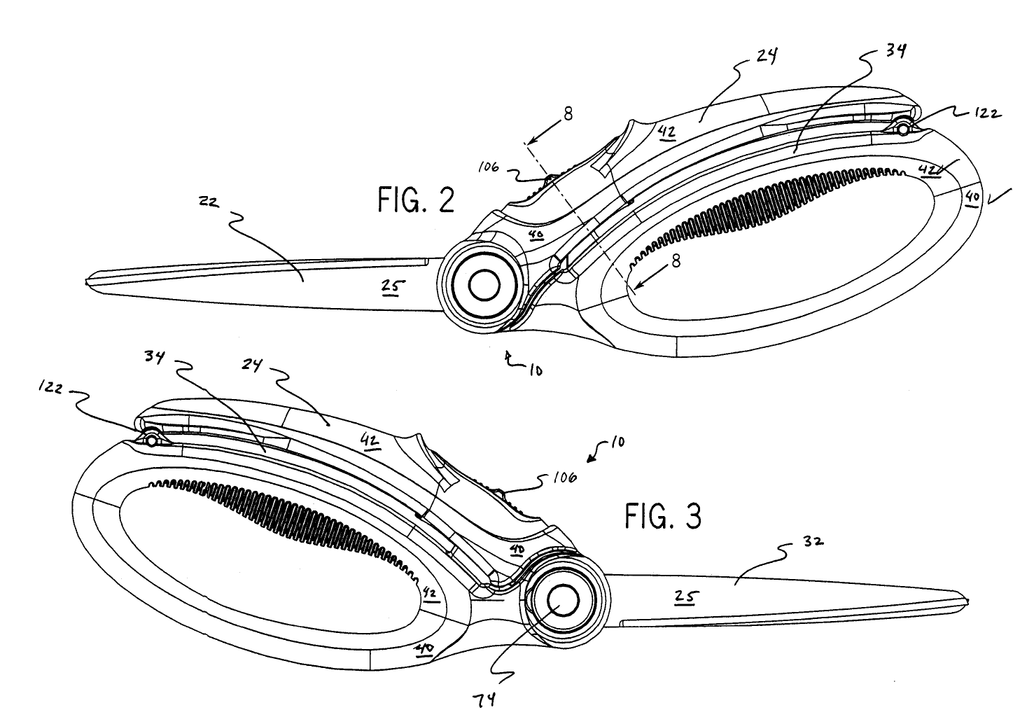

The handles 24, 34 may be formed by overmolding the flexible grip material 42 over the rigid base material 40 through any suitable process such as injection molding. The handles 24, 34 also may be ribbed, as shown in the bottom handle 34 of the embodiment of FIGS. 2 and 3. Scissors with handle overmolding and ribbing are known in the art, such as disclosed in pending U.S. patent application Ser. No. 11/231,303, which is incorporated herein by reference.

A coating 25 may be disposed on the first blade 22 and second blade 32 to enhance hardness, durability, or resistance to corrosion, or to provide an aesthetically acceptable appearance. Suitable coatings may include titanium nitride, chromium nitride, or a combination of titanium nitride and chromium nitride. Suitable coatings are known in the art, such as disclosed in U.S. patent application Ser. No. 10/720,578, U.S. patent application Ser. No. 11/231,259, and U.S. patent application Ser. No. 11/231,151, which are incorporated herein by reference.

Referring now to the embodiment in FIG. 5, the first scissor member 20 and second scissor member 30 are connected at a pivot assembly (not shown). The pivot assembly may be any suitable structure, such as a screw and a post, a rivet, or a nut-and-bolt assembly. As shown in FIG. 5, the pivotal assembly comprises a post 62 in the first scissor member 20, an aperture 64 in the second scissor member 30, a metal washer 66, a plastic washer 68, and a screw 70. The two scissor members 20, 30 are pivotally connected by the screw 70, driven through the washers 66, 68 and the aperture 64 in the second scissor member 30, and into the post 62 of the first scissor member 20. The screw 70 has a head 72 which may be concealed by a cover 74. The washers 66, 68 and screw head 72 are received within a recess 79 in the second scissor member 30. The metal washer 66 may have a notch 76 that secures to a corresponding nub 78 on recess 79 of the second scissor member 30.

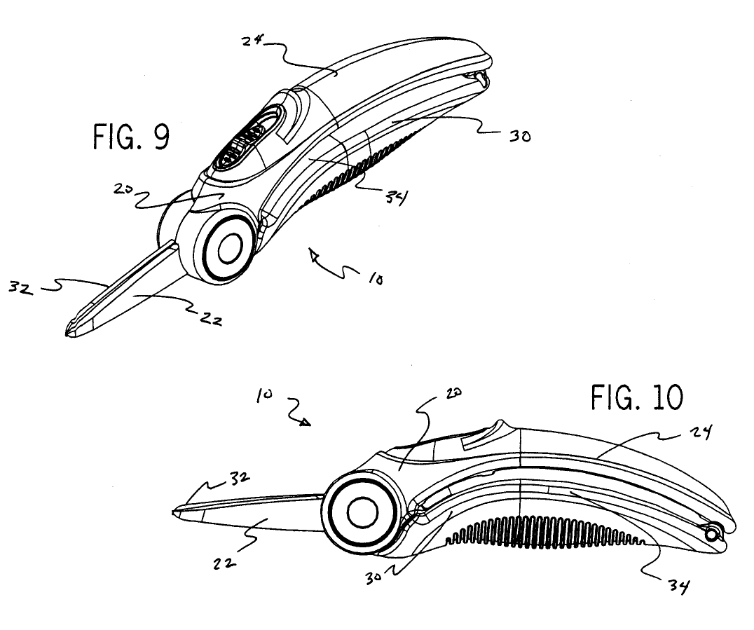

As shown in FIGS. 2-3 and FIGS. 6-7, the top handle 24 and bottom handle 34 may be angularly offset from the first and second blades 22, 32. The angular offset enhances ease of use of the scissors assembly 10, as it allows the blades 22, 32 to be positioned roughly parallel to a cutting surface (not shown) without requiring a user to grip the handles 24, 34 in the same parallel position. Alternately, as in the embodiment shown in FIGS. 9 and 10, the top handle 24 and bottom handle 34 may be substantially parallel to the first and second blades 22, 32.

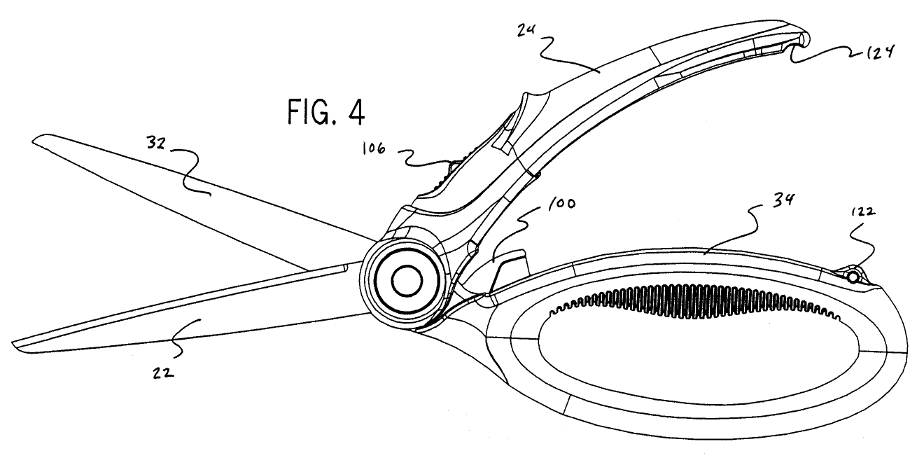

Referring again to the embodiment of FIG. 6, the first scissor member 20 has a first cavity 80 around the post 62. In FIG. 7, it can be seen that the second scissor member 30 has a corresponding second cavity 82 around the aperture 64. The cavities 80, 82 are generally symmetrical, and align with one another to form a chamber (not shown). The chamber houses a biasing means such as a torsion spring 84, as shown in FIG. 5. A first end (not shown) of the torsion spring 84 terminates within the first cavity 80, and a second end 88 of the torsion spring 84 terminates within the second cavity 82. The force of the torsion spring 84 biases the scissor assembly 10 into an open position, as shown in FIG. 4. The chamber may be substantially watertight, such as by application of a sealant (not shown) near the chamber formed by the first and second scissor members 20, 30.

The embodiments of FIGS. 6 and 7 further show that the scissor assembly 10 may have an open angle limiter (not shown) comprising an arcuate recess 90 in the second scissor assembly 30 which receives a corresponding peg 92 extending from the first scissor assembly 20. The arcuate recess 90 has a first end 91 and a second end 93. The force of the torsion spring 84 forces the peg 92 to the first end 91 of the arcuate recess 90, at which point the angle between the open first and second blades 22, 32 is limited by the length of the arcuate recess 90. As a user applies opposing forces to the top and bottom handles 24, 34, the peg 92 travels toward the second end 93 of the arcuate recess 90.

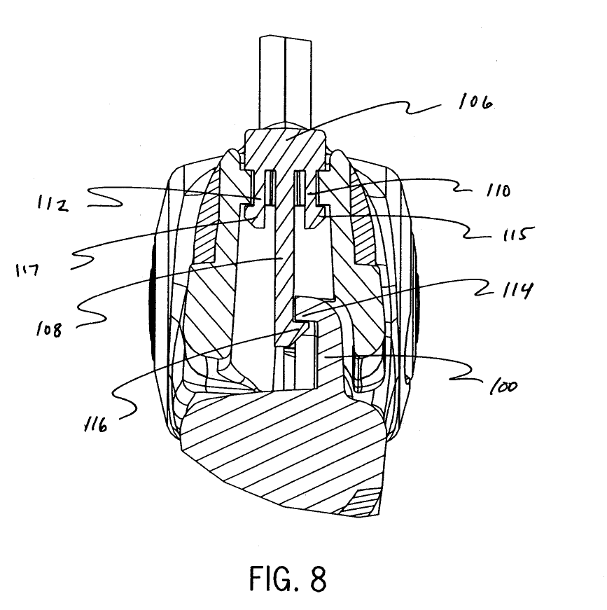

As shown in FIGS. 5 and 8, the scissors assembly 10 has a locking mechanism (not shown). As seen in the embodiment of FIG. 5, the locking mechanism may comprise a fin 100 integrally formed with and extending from the bottom handle 34, and a locking switch 102, which extends through an aperture 104 in the top handle 24. The locking switch 102 has a button 106 that is wider than the aperture 104, and a tang 108 that is narrower than the aperture 104. The locking switch 102 also has a first side support 110 and a second side support 112, which have a first flange 115 and a second flange 117, allowing the switch 102 to be snap-fitted into the aperture 104. The fin 100 has a first catch 114 and the tang 108 has a second catch 116. The first and second catches 114, 116 are opposed to one another. When the scissors assembly 10 is in a closed position, a user may apply pressure to the button 106 to slidably move the locking switch 102 from an unlocked position (not shown) to a locked position as shown in FIG. 8. In the locked position, the first and second catches 114, 116 engage one another to prevent the force of the torsion spring 84 from biasing the scissors assembly 10 in to an open position as in FIG. 4.

FIGS. 2-5 show an exemplary embodiment of the invention wherein the second scissor member 30 has a tether receiver 122 to which may be attached a tether (not shown), and the first scissor member 20 has a corresponding recess 124, as shown in FIG. 4. The tether, such as a lanyard or a string, allows for convenient location, safekeeping and storage of the scissors assembly 10 by a user. In an alternate embodiment (not shown), the first scissor member 20 may have the tether receiver 122, and the second scissor member 30 may have the recess 124. In the embodiment shown in FIGS. 2-5, the tether receiver 122 also serves to limit the closed angle of the blades 22, 32 by ensuring that in a closed position, the recess 124 of the top handle 24 contacts the tether receiver 122 of the bottom handle 24 at a position that corresponds to the blades 22, 32 being substantially parallel.

In general, while the present invention has been shown and described in terms of preferred embodiments, it is recognized that equivalents, alternatives, and modifications aside form those expressly stated are possible and within the scope of the invention.

We claim:

1. A scissors, comprising:
a first scissor member having a top handle and a first blade;
a second scissor member having a bottom handle and a second blade;
a pivot assembly connecting the first scissor member and the second scissor member;
a spring enclosed in a chamber, wherein the spring is proximate to the pivot assembly and which spring biases the scissors to an open position; and
a locking mechanism for securing the first scissor member and the second scissor member in a closed position.

2. The scissors of claim 1, further comprising a finger guard integrally formed with the bottom handle.

3. The scissors of claim 1, further comprising an open angle limiter.

4. The scissors of claim 1, wherein the blades have a coating.

5. The scissors of claim 4, wherein the coating is comprised of titanium nitride and chromium nitride.

6. The scissors of claim 1, further comprising:
a top resilient surface on the top handle; and
a bottom resilient surface on the bottom handle.

7. The scissors of claim 6, wherein the bottom resilient surface is ribbed.

8. The scissors of claim 1, further comprising a tether receiver.

9. The scissors of claim 1, wherein the handles of the first and second scissor members are angularly offset in relation to the first and second blades.

10. A scissors, comprising:
a first scissor member comprising a top handle, a first cavity, and a first blade having a first inner surface;
a second scissor member comprising a bottom handle, a second cavity, and a second blade having a second inner surface;
a pivot assembly connecting the first scissor member and the second scissor member, whereby the first inner surface and the second inner surface are oriented to face one another;
wherein the first and second cavities align with one another to form a chamber around the pivot assembly when the first and second scissor members are pivotally connected;
a biasing means within the chamber for biasing the first scissor member and the second scissor member to an open position;
an open angle limiter peripheral to the chamber; and
a locking mechanism for restricting the first scissor member and the second scissor member to a closed position.

11. The scissors of claim 10, wherein the biasing means is a torsion spring having a first end terminating within the first cavity and a second end terminating within the second cavity.

12. The scissors of claim 10, wherein the first or second scissor member has a tether receiver on the handle located near the first proximate end and a tether, secured to the tether receiver.

13. The scissors of claim 12, wherein the scissor member not having the tether receiver has a recess for receiving the tether receiver when the scissors is in a closed position.

14. The scissors of claim 12 wherein the tether receiver is located on the bottom handle of the second scissor member and is situated to contact the top handle of the first scissor member to ensure that said first blade and said second blade are oriented approximately parallel to one another when the scissors are in a closed position.

15. The scissors of claim 10, wherein the locking mechanism comprises:
an aperture in said top handle proximate to said pivot location;
a fin extending upwardly from the upper surface of the bottom handle, the fin sized to fit within the aperture and the fin having a first catch;
a locking switch slidably mounted to the aperture, the switch having a button that is wider than said aperture and a tang that is narrower than said aperture, the tang extending from the button and through the aperture, wherein the tang has a second catch opposed to the first catch, and wherein the tang slidably engages said second catch with said first catch to lock the scissors in a closed position.

16. The scissors of claim 10, wherein the handles of the first and second scissor members are angularly offset in relation to the first and second blades.

17. The scissors of claim 10, wherein the chamber is substantially watertight.

18. The scissors claim 10, wherein the top and bottom handles have overmolding and the bottom handle has ribbing.

19. A scissors, comprising:
a first scissor member comprising a top handle and a first blade having a first inner surface, the first blade extending forwardly of the top handle and ending at a first distal end, the top handle extending rearwardly of the first blade and ending at a first proximate end, the top handle being slightly curved, and the top handle having a rigid base material and a resilient grip material;
a second scissor member comprising a bottom handle and a second blade having a second inner surface, the second blade extending forwardly of the bottom handle and ending at a second distal end, the bottom handle extending rearwardly of the second blade and ending at a second proximate end, the bottom handle being slightly curved, having a finger guard, having a rigid base material and a resilient grip material, wherein the grip material is ribbed;
a pivot assembly connecting the first scissor member and the second scissor member, whereby the first inner surface and the second inner surface are oriented to face one another, the first scissor member and the second scissor member being pivotable between an open position wherein the first and second blades are oriented transversely to one another and a closed position wherein the first and second blades are oriented approximately parallel to one another;
wherein the first scissor member has a first cavity and the second scissor member has a second cavity, the first and second cavities opposed to one another and aligning with one another when the first and second scissor members are pivotally connected to form a chamber around the means for pivotally connecting the first and second scissor members;
a biasing means within the chamber for biasing the first scissor member and the second scissor member to an open position;
an open angle limiter peripheral to the chamber; and
a locking mechanism for restricting the first scissors member and the second scissors member to a closed position.

20. The scissors of claim 19, wherein the blades have a coating comprised of titanium nitride and chromium nitride.
